(19) United States
(12) Patent Application Publication
(10) Pub. No.: US 2026/0073510 A1
(43) Pub. Date: Mar. 12, 2026

(54) METHODS AND SYSTEMS FOR 3D MEDICAL IMAGE ANALYSIS

(71) Applicant: FUJIFILM Healthcare Americas Corporation, Lexington, MA (US)

(72) Inventors: Azuma Takahashi, Durham, NC (US); Michael Wakim, Culver City, CA (US); Jasmin Mulligan, Seattle, WA (US); Takashi Hirano, Durham, NC (US); Brigil Vincent, Durham, NC (US); Keiichi Morita, Cary, NC (US)

(73) Assignee: FUJIFILM Healthcare Americas Corporation, Lexington, MA (US)

(21) Appl. No.: 18/882,159

(22) Filed: Sep. 11, 2024

(51) Int. Cl. G06T 7/00; G06T 7/62; G06T 11/00

(52) U.S. Cl. CPC G06T 7/0012; G06T 7/62; G06T 12/00; G06T 2200/24; G06T 2207/10081; G06T 2207/30101

(57) ABSTRACT

Methods and systems for 3D image analysis including identifying a region of interest of a blood vessel in a medical image. The methods and systems include identifying a first point disposed on the blood vessel, the first point being a first center point of the blood vessel on a first side of the region of interest and identifying a second point disposed on the blood vessel, the second point being a second center point of the blood vessel on a second side of the region of interest. The methods and systems include generating a curved planar reconstruction (CPR) image of a portion of the blood vessel, the portion extending from the first point to the second point and including the region of interest and determining the diameter of the blood vessel at the region of interest.

### BACKGROUND

### 1. Field of Disclosed Subject Matter

The disclosed subject matter is directed to systems and methods for 3D medical image analysis. Particularly, the disclosed subject matter is directed to techniques to analyze vessel disease, and for example, to determine a diameter of the vessel at a region of interest.

### 2. Description of Related Art

In medical imaging, Picture Archiving and Communication Systems (“PACS”) are a combination of computers and networks dedicated to the storage, retrieval, presentation, and distribution of images. While medical information can be stored in a variety of formats, a common format of image storage is DICOM. DICOM is a standard in which, among other things, medical images and associated meta-data can be communicated from imaging modalities (e.g., x-ray (or x-rays' digital counterparts: computed radiography (“CR”), digital radiography (“DR”)), computed tomography (“CT”), and magnetic resonance imaging (“MRI”) apparatuses) to remote storage and/or client devices for viewing and/or other use.

When reviewing 3-dimensional (“3D”) medical images, such as CT or MRI images, radiologists can use volume visualization techniques, including curved planar reconstruction (“CPR”) techniques, to analyze vessel disease, such as vessel stenosis and aneurysms. Typically, a user can identify two points on a blood vessel on either side of the diseased location, and CPR techniques can be used between the two points to aid volume visualization. However, the effort can be a burden for users.

Accordingly, there is a need to improve efficiency of identifying diseased areas, locations to perform CPR techniques, and related analysis.

### SUMMARY

The purposes and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as the appended figures.

To achieve these and other advantages and in accordance with the purpose of the disclosed subject matter, as embodied and broadly described, the disclosed subject matter is directed to systems and methods for 3D medical image analysis. The method includes identifying, by one or more computing devices, a region of interest of a blood vessel in a medical image. The method includes identifying, by the one or more computing devices, a first point disposed on the blood vessel, the first point being a first center point of the blood vessel on a first side of the region of interest and identifying, by one or more computing devices, a second point disposed on the blood vessel, the second point being a second center point of the blood vessel on a second side of the region of interest. The method includes generating, by the one or more computing devices, a curved planar reconstruction (“CPR”) image of a portion of the blood vessel, the portion extending from the first point to the second point and including the region of interest; and determining, by the one or more computing devices, the diameter of the blood vessel at the region of interest.

In accordance with the disclosed subject matter the region of interest can be a stenosis. The region of interest can be an aneurysm. The method can include receiving, prior to generating the CPR image, an adjustment of the first point from a user. Additionally or alternatively, the method can include receiving, prior to generating the CPR image, an adjustment of the second point from a user.

In accordance with the disclosed subject matter, the method can include displaying the diameter on a user interface. The method can include determining a diagnosis based on the diameter and displaying the diagnosis on a user interface. The method can include providing a treatment associated with the region of interest and based on the diameter of the blood vessel at the region of interest.

In accordance with the disclosed subject matter, one or more computer readable non-transitory storage media embodying software is provided. The software is operable when executed to: identify a region of interest of a blood vessel in a medical image; identify a first point disposed on the blood vessel, the first point being a first center point of the blood vessel on a first side of the region of interest; identify a second point disposed on the blood vessel, the second point being a second center point of the blood vessel on a second side of the region of interest; and generate a CPR image of a portion of the blood vessel, the portion including the region of interest; determine the diameter of the blood vessel at the region of interest.

In accordance with the disclosed subject matter, a system including one or more hardware processors; and a memory coupled to the processors including instructions executable by the processors is provided. The processors are operable when executing the instructions to: identify a region of interest of a blood vessel in a medical image; identify a first point disposed on the blood vessel, the first point being a first center point of the blood vessel on a first side of the region of interest; identify a second point disposed on the blood vessel, the second point being a second center point of the blood vessel on a second side of the region of interest; and generate a curved planar reconstruction (“CPR”) image of a portion of the blood vessel, the portion including the region of interest; and determine the diameter of the blood vessel at the region of interest.

### DRAWINGS

FIG. 1 shows a hierarchy of medical image records that can be filtered and displayed in accordance with the disclosed subject matter.

FIG. 2 shows the architecture of a system for 3D image analysis, in accordance with the disclosed subject matter.

FIG. 3 shows a medical image including a portion of a blood vessel, in accordance with the disclosed subject matter.

FIG. 4 shows a CPR image of a portion of the blood vessel shown in FIG. 3.

FIG. 5 shows a CPR image of a portion of a blood vessel having a stenosis, in accordance with the disclosed subject matter.

FIG. 6 shows a CPR image of a portion of a blood vessel having an aneurysm, in accordance with the disclosed subject matter.

FIG. 7 shows a flow chart of a method in accordance with the disclosed subject matter.

### DETAILED DESCRIPTION

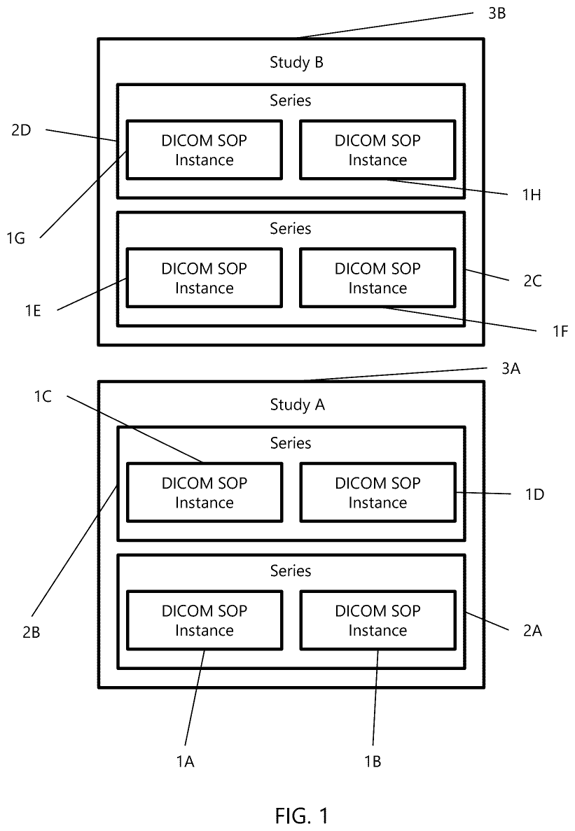

Reference will now be made in detail to various exemplary embodiments of the disclosed subject matter, exemplary embodiments of which are illustrated in the accompanying drawings. For purpose of illustration and not limitation, the systems and methods are described herein with respect to analyzing images, and particularly, digital medical images (also referred to as “medical images”), such as DICOM images. However, the methods and systems described herein can be used for analyzing any digital image. As used in the description and the appended claims, the singular forms, such as “a,” “an,” “the,” and singular nouns, are intended to include the plural forms as well, unless the context clearly indicates otherwise. Accordingly, as used herein, the term medical image can refer to one medical image, or a plurality of medical images. For example, and with reference to FIG. 1 for purpose of illustration and not limitation, as referred to herein a medical image record can include a single DICOM Service-Object Pair (“SOP”) Instance (also referred to as “DICOM Instance” “DICOM image” and “image”) 1 (e.g., 1A-1H), one or more DICOM SOP Instances 1 in one or more Series 2 (e.g., 2A-D), one or more Series 2 inside one or more Studies 3 (e.g., 3A, 3B), and one or more Studies 3.

Referring to FIGS. 1-6 for purpose of illustration and not limitation, the disclosed system 100 can be configured to analyze images. For example, system 100 can be configured to analyze images such as DICOM images (e.g., 1A-1H). The system 100 can include one or more computing devices defining a server 30 and user workstation 60. The user workstation 60 can be coupled to the server 30 by a network. The network, for example, can be a Local Area Network (“LAN”), a Wireless LAN (“WLAN”), a virtual private network (“VPN”), or any other network that allows for any radio frequency or wireless type connection. For example, other radio frequency or wireless connections can include, but are not limited to, one or more network access technologies, such as Global System for Mobile communication (“GSM”), Universal Mobile Telecommunications System (“UMTS”), General Packet Radio Services (“GPRS”), Enhanced Data GSM Environment (“EDGE”), Third Generation Partnership Project (“3GPP”) Technology, including Long Term Evolution (“LTE”), LTE-Advanced, 3G technology, Internet of Things (“IOT”), fifth generation (“5G”), or new radio (“NR”) technology. Other examples can include Wideband Code Division Multiple Access (“WCDMA”), Bluetooth, IEEE 802.11b/g/n, or any other 802.11 protocol, or any other wired or wireless connection.

Workstation 60 can take the form of any known client device. For example, workstation 60 can be a computer, such as a laptop or desktop computer, a personal data or digital assistant (“PDA”), or any other user equipment or tablet, such as a mobile device or mobile portable media player. Server 30 can be a service point which provides processing, database, and communication facilities. For example, the server 30 can include dedicated rack-mounted servers, desktop computers, laptop computers, set top boxes, integrated devices combining various features, such as two or more features of the foregoing devices, or the like. Server 30 can vary widely in configuration or capabilities, but can include one or more server processors 31, PACS server 32, AI processing server 33, memory, and/or transceivers. Although illustrated as separate elements, one or more of the server processors 31, PACS server 32, AI processing server 33 can be combined. Server 30 can also include one or more mass storage devices, one or more power supplies, one or more wired or wireless network interfaces, one or more input/output interfaces, and/or one or more operating systems.

A user can be any person authorized to access workstation 60 and/or server 30, including a health professional, medical technician, researcher, or patient. In some embodiments a user authorized to use the workstation 60 and/or communicate with the server 30 can have a username and/or password that can be used to login or access workstation 60 and/or server 30.

Workstation 60 can include GUI 65, memory 61, processor 62, transceiver 63, input/output 64, and AI module 66. Medical image records (such as mammograms) received by workstation 60 can be processed using one or more processors 62. Processor 62 can be any hardware or software used to execute computer program instructions. These computer program instructions can be provided to a processor of a general purpose computer to alter its function to a special purpose, a special purpose computer, application-specific integrated circuit (“ASIC”), or other programmable digital data processing apparatus, such that the instructions, which execute via the processor of the workstation 60 or other programmable data processing apparatus, implement the functions/acts specified in the block diagrams or operational block or blocks, thereby transforming their functionality in accordance with embodiments herein. The processor 62 can be a portable embedded micro-controller or micro-computer. For example, processor 62 can be embodied by any computational or data processing device, such as a central processing unit (“CPU”), digital signal processor (“DSP”), ASIC, programmable logic devices (“PLDs”), field programmable gate arrays (“FPGAs”), digitally enhanced circuits, or comparable device or a combination thereof. The processor 62 can be implemented as a single controller, or a plurality of controllers or processors. The input/output 64 can be any suitable input/output, for example, a mouse or keyboard. In accordance with the disclosed subject matter, input/output 64 can be integrated with GUI 65 in the form of a touchscreen. Input/output 64 can be implemented as a single input/output 64 or a plurality of input/outputs 64. GUI 65 can be controlled by one or more computing devices which can be on the workstation 60, server 30, or both.

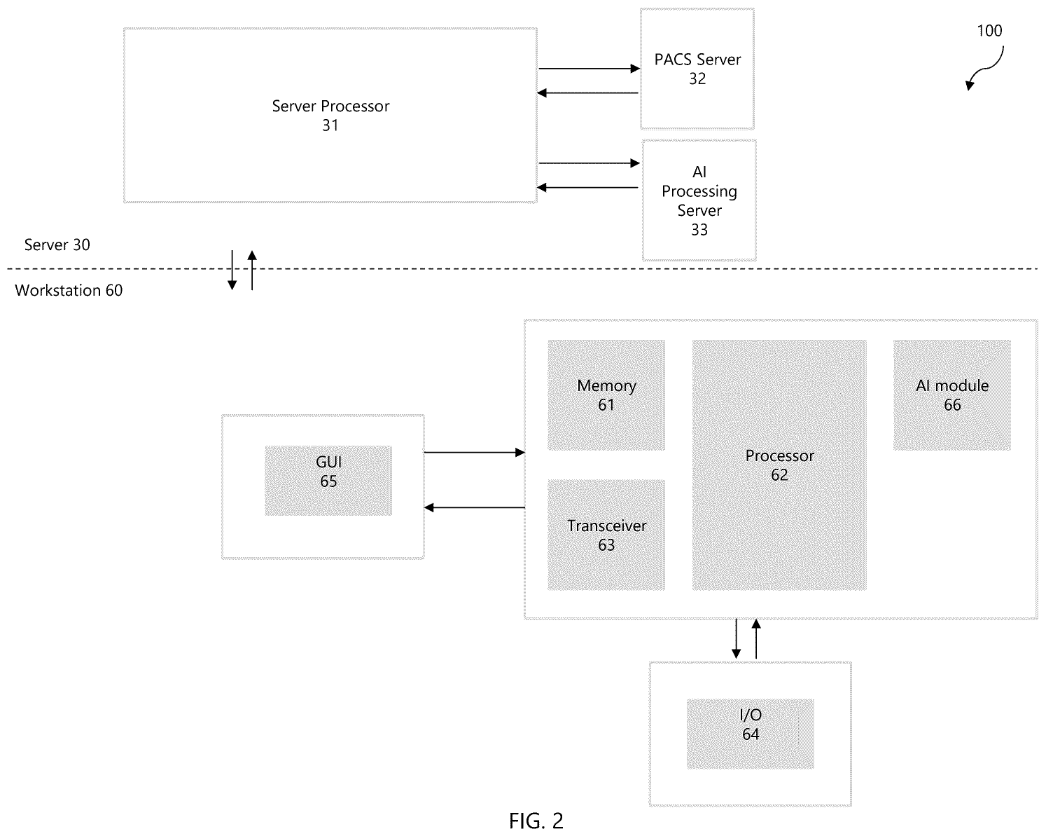

Workstation 60 can send and receive medical image records (such as CT scans) from server 30 using transceiver 63. Transceiver 63 can, independently, be a transmitter, a receiver, or both a transmitter and a receiver, or a unit or device that can be configured both for transmission and reception. In other words, transceiver 63 can include any hardware or software that allows workstation 60 to communicate with server 30. Transceiver 63 can be either a wired or a wireless transceiver. When wireless, the transceiver 63 can be implemented as a remote radio head which is not located in the device itself, but in a mast. While FIG. 2 only illustrates a single transceiver 63, workstation 60 can include one or more transceivers 63. Memory 61 can be a non-volatile storage medium or any other suitable storage device, such as a non-transitory computer-readable medium or storage medium. For example, memory 61 can be a random-access memory (“RAM”), read-only memory (“ROM”), hard disk drive (“HDD”), erasable programmable read-only memory (“EPROM”), electrically erasable programmable read-only memory (“EEPROM”), flash memory or other solid-state memory technology. Memory 61 can also be a compact disc read-only optical memory (“CD-ROM”), digital versatile disc (“DVD”), any other optical storage, magnetic cassettes, magnetic tape, magnetic disk storage or other magnetic storage devices, or any other physical or material medium which can be used to tangibly store the desired information or data or instructions and which can be accessed by a computer or processor. Memory 61 can be either removable or non-removable.

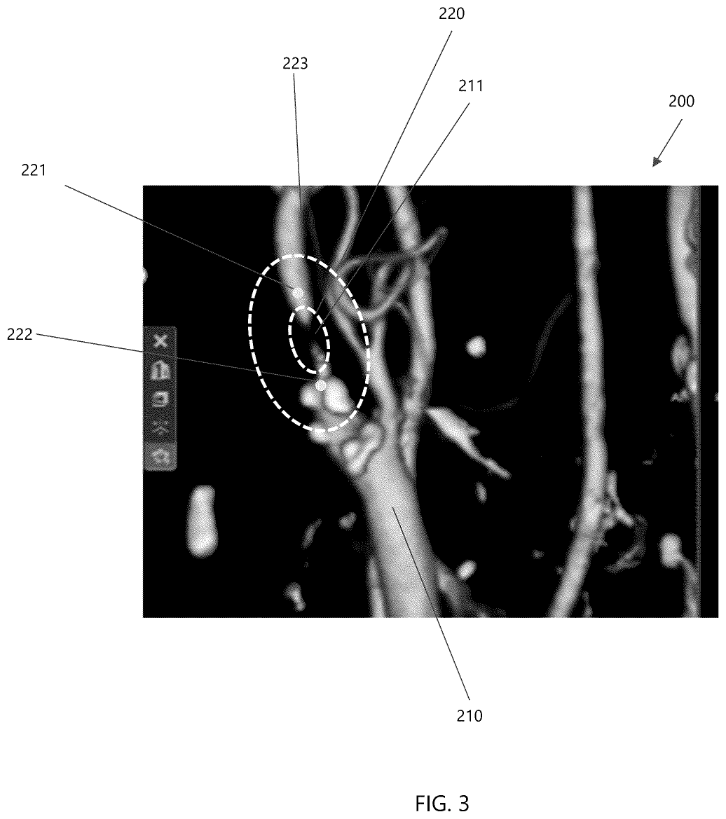

FIG. 3 shows medical image 200, which can be displayed, for example, on GUI 65. Medical image 200 can be a 3D medical image, such as CT or MRI images. The medical image 200 can show a blood vessel 210 including a region of interest 220 and a region for generating a CPR image 223. The region of interest 220 can include a vascular lesion on a diseased portion of blood vessel 210. For example, region of interest 220 includes stenosed region 211 of blood vessel 210. As another example, the region of interest 200 can include an aneurysm. Medical image 200 also includes two points 221, 222 disposed on the blood vessel 210. The first point 221 is at a first center point of blood vessel 210 and on a first side of the region of interest 220; second point 222 is at a second center point of blood vessel 210 and on a second side of the region of interest 220.

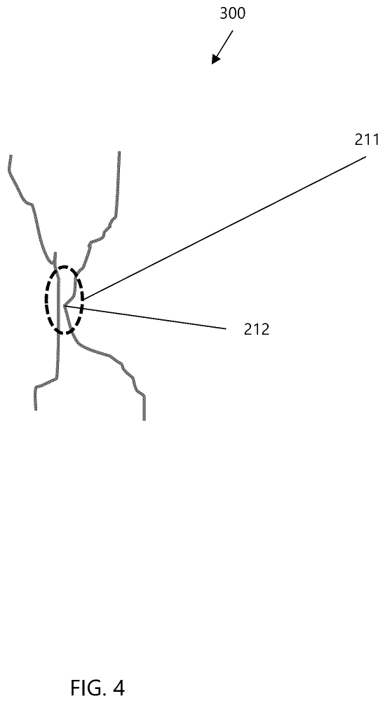

FIG. 4 shows a CPR image 300 of a portion (region 223) of blood vessel 210. Since the region for generating a CPR image 223 is larger than the region of interest 220, the CPR image 300 is generated from an image area that is larger than the stenosed region 211. The CPR image includes region of interest 220, including stenosed region 211 of blood vessel 210.

In operation, system 100 can receive a request from a user (for example, a doctor, nurse, or other medical practitioner) to view a medical image 200 and perform an analysis of the medical image 200. The user can provide the request at workstation 60 via input/output 64. The medical image 200 can be transferred from server 30 to workstation 60, or can be initially stored memory 61. The medical image 200 can be displayed on GUI 65.

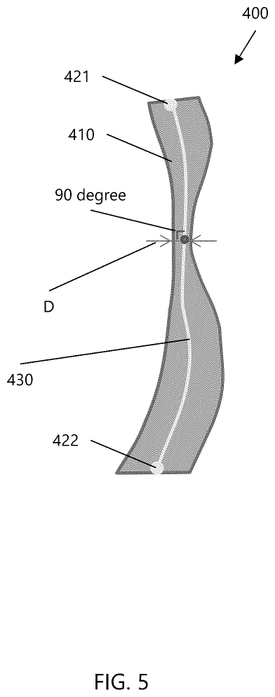

System 100 can detect stenosed region 211, and identify the region of interest 220. Detecting the stenosed region 211 can be performed by AI module 66 and can include a combination of segmentation (extracting a blood vessel automatically from a medical image) and detection (detecting endpoints, stenotic vessel, aneurysm, or other vessel lesions and/or abnormalities). The system 100 can then identify first point 221 and second point 222. The system 100 can identify the region for generating a CPR image 223, which can include at least a portion of the blood vessel 210 extending from the first point 221 and the second point 222, and include the region of interest 220. System 100 can generate a center line (e.g., 430, 530 shown in FIGS. 4 and 5, respectively) which can extend from first point 221 to second point 222 through the stenosed region 211. The center line (e.g., 430, 530) can run along a center of the blood vessel 210. System 100 can display blood vessel 210 on GUI 65. Additionally, one or more of the first point 221, second point 222, center line (e.g., 430, 530), region of interest 220, and the region for generating a CPR image 223 can be displayed on GUI 65. One or more of the region of interest 220, first point 221, second point 222, and center line (e.g., 430, 530) can be adjusted by a user. Additionally or alternatively, the user can edit entire points for center line (e.g., 430, 530), which can be generated by the blood vessel extraction module. For example, a user can adjust the first point 221 or the second point 222 by clicking and dragging the points 221, 222. System 100 can generate a CPR image 300, which can be displayed on GUI 65. For example, CPR image 300 can be generated based on region for generating a CPR image 223 of blood vessel 210, blood vessel 210, first point 221, second point 222, and center line (e.g., 430, 530). System 100 can determine a diameter D of the stenosed region 211 based on the CPR image 300. The diameter D can be measured at the most severe stenosis point, such as where the diameter D of the blood vessel 210 is the smallest. The diameter D can be measured perpendicular to the center line (e.g., 430, 530) at the most severe stenosis point. The diameter D can be measured in every slice in the CPR image 300. The diameter D can be displayed on GUI 65.

In accordance with he disclosed subject matter, system 100 can provide a diagnosis based on the diameter D. For example, the system 100 can identify a blood vessel having a stenosis or an aneurism and provide information regarding the risk for further problems (e.g., a clot or a rupture). Additionally or alternatively, system 100 can provide treatment proposals, such as whether a stent should be placed, whether a stent graft should be provided for an aneurism, or whether certain drug treatment should be initiated.

AI module 66 can be trained with 3D images of blood vessels including those with aneurisms and those with stenosis. At least some of the training images can be marked by doctors (for example to identify vessels, aneurisms, and stenosis) to provide initial information to the AI module 66.

In accordance with the disclosed subject matter, system 100 can make a user's efforts more efficient and can save a user's time. For example, without automatically identifying the blood vessel, lesion, and points, the efforts need to be performed manually by a user.

FIG. 5 shows a CPR image 400 of blood vessel 410 having a stenosis. The CPR image 400 includes first point 421 and second point 422, as well as center line 430 extending between the first and second points 421, 422. The center line 430 extends along the center of blood vessel 410, and through the stenosed of the blood vessel 430. Diameter D is marked at the most stenosed portion of the blood vessel 430, and is shown measured perpendicular to center line 430. One or more of the region of first point 421, second point 422, center line 430, and the location that diameter D is measured can be adjusted by a user.

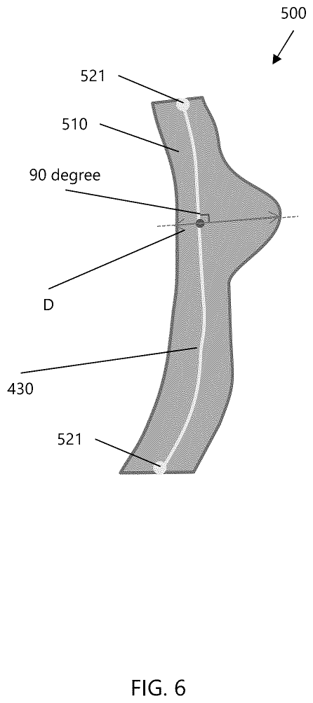

FIG. 6 shows a CPR image 500 of blood vessel 510 having an aneurysm. The CPR image 500 includes first point 521 and second point 522, as well as center line 530 extending between the first and second points 521, 522. The center line 530 extends along the center of blood vessel 510, and through the aneurism. Diameter D is marked at the portion of the aneurism with the largest diameter, and is shown measured perpendicular to center line 530. One or more of the region of first point 521, second point 522, center line 530, and the location that diameter D is measured can be adjusted by a user.

Although described with respect to blood vessels, stenosis, and aneurisms, the disclosed subject matter is not limited to such use. The disclosed systems and methods can be used to identify other blood vessel abnormalities, such as aortic dissection. Likewise, the disclosed systems and methods can be used on other lumens in the body, such as biliary ducts, organs, the gastrointestinal tract, and air passageways in the lungs, as well as corresponding diseases.

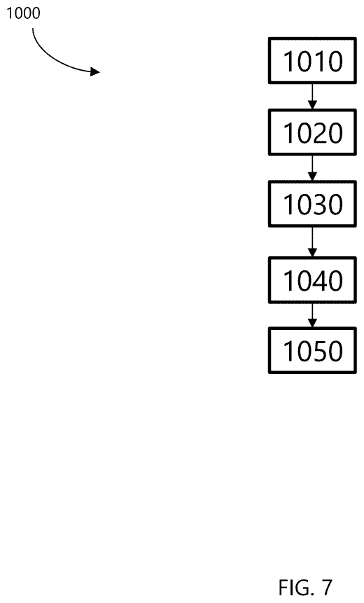

FIG. 7 illustrates an example method 1000 in accordance with the disclosed subject matter. The method can begin at 1010, wherein the method includes identifying, by one or more computing devices, a region of interest of a blood vessel in a medical image. At 1020, the method can include identifying, by the one or more computing devices, a first point disposed on the blood vessel, the first point being a first center point of the blood vessel on a first side of the region of interest. At 1030, the method can include identifying, by one or more computing devices, a second point disposed on the blood vessel, the second point being a second center point of the blood vessel on a second side of the region of interest. At 1040, the method can include generating, by the one or more computing devices, a curved planar reconstruction (CPR) image of a portion of the blood vessel, the portion extending from the first point to the second point and including the region of interest. At 1050, the method can include determining, by the one or more computing devices, the diameter of the blood vessel at the region of interest. In accordance with the disclosed subject matter, the method can repeat one or more steps of the method of FIG. 7, where appropriate. Although this disclosure describes and illustrates particular steps of the method of FIG. 7 as occurring in a particular order, this disclosure contemplates any suitable steps of the method of FIG. 7 occurring in any suitable order. Moreover, although this disclosure describes and illustrates an example method including the particular steps of the method of FIG. 7, this disclosure contemplates any suitable method including any suitable steps, which can include all, some, or none of the steps of the method of FIG. 7, where appropriate. Furthermore, although this disclosure describes and illustrates particular components, devices, or systems carrying out particular steps of the method of FIG. 7, this disclosure contemplates any suitable combination of any suitable components, devices, or systems carrying out any suitable steps of the method of FIG. 7.

The subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus.

A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium also can be, or may be included in, one or more separate physical components or media (e.g., multiple CDs, disks, or other storage devices).

The term “processor” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA or an ASIC. The apparatus also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program can, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA or an ASIC.

Processors suitable for the execution of a computer program can include, by way of example and not by way of limitation, both general and special purpose microprocessors. Devices suitable for storing computer program instructions and data can include all forms of non-volatile memory, media and memory devices, including by way of example but not by way of limitation, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

Additionally, as described above in connection with certain embodiments, certain components can communicate with certain other components, for example via a network, e.g., a local area network or the internet. To the extent not expressly stated above, the disclosed subject matter is intended to encompass both sides of each transaction, including transmitting and receiving. One of ordinary skill in the art will readily understand that with regard to the features described above, if one component transmits, sends, or otherwise makes available to another component, the other component will receive or acquire, whether expressly stated or not.

In addition to the specific embodiments claimed below, the disclosed subject matter is also directed to other embodiments having any other possible combination of the dependent features claimed below and those disclosed above. As such, the particular features presented in the dependent claims and disclosed above can be combined with each other in other possible combinations. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the methods and systems of the disclosed subject matter without departing from the spirit or scope of the disclosed subject matter. Thus, it is intended that the disclosed subject matter include modifications and variations that are within the scope of the appended claims and their equivalents.

1. A method, comprising:
identifying, by one or more computing devices, a region of interest of a blood vessel in a medical image;
identifying, by the one or more computing devices, a first point disposed on the blood vessel, the first point being a first center point of the blood vessel on a first side of the region of interest;
identifying, by one or more computing devices, a second point disposed on the blood vessel, the second point being a second center point of the blood vessel on a second side of the region of interest;
generating, by the one or more computing devices, a curved planar reconstruction (CPR) image of a portion of the blood vessel, the portion extending from the first point to the second point and including the region of interest; and
determining, by the one or more computing devices, the diameter of the blood vessel at the region of interest.

2. The method of claim 1, wherein the region of interest comprises a stenosis.

3. The method of claim 1, wherein the region of interest comprises an aneurysm.

4. The method of claim 1, further comprising receiving, prior to generating the CPR image, an adjustment of the first point from a user.

5. The method of claim 1, further comprising receiving, prior to generating the CPR image, an adjustment of the second point from a user.

6. The method of claim 1, further comprising displaying the diameter on a user interface.

7. The method of claim 1, further comprising determining a diagnosis based on the diameter and displaying the diagnosis on a user interface.

8. The method claim 1, further comprising providing a treatment associated with the region of interest and based on the diameter of the blood vessel at the region of interest.

9. One or more computer readable non-transitory storage media embodying software that is operable when executed to:
identify a region of interest of a blood vessel in a medical image;
identify a first point disposed on the blood vessel, the first point being a first center point of the blood vessel on a first side of the region of interest;
identify a second point disposed on the blood vessel, the second point being a second center point of the blood vessel on a second side of the region of interest; and
generate a curved planar reconstruction (CPR) image of a portion of the blood vessel, the portion including the region of interest;
determine the diameter of the blood vessel at the region of interest.

10. The computer readable non-transitory storage media of claim 9, wherein the region of interest comprises a stenosis.

11. The computer readable non-transitory storage media of claim 9, wherein the region of interest comprises an aneurysm.

12. The computer readable non-transitory storage media of claim 9, further comprising receiving, prior to generating the CPR image, an adjustment of the first point from a user.

13. The computer readable non-transitory storage media of claim 9, further comprising receiving, prior to generating the CPR image, an adjustment of the second point from a user.

14. The computer readable non-transitory storage media of claim 9, further comprising displaying the diameter on a user interface.

15. The computer readable non-transitory storage media of claim 9, further comprising determining a diagnosis based on the diameter and displaying the diagnosis on a user interface.

16. The computer readable non-transitory storage media claim 9, further comprising providing a treatment method associated with the region of interest and based on the diameter of the blood vessel at the region of interest.

17. A system comprising: one or more hardware processors; a memory coupled to the processors comprising instructions executable by the processors, the processors being operable when executing the instructions to:
identify a region of interest of a blood vessel in a medical image;
identify a first point disposed on the blood vessel, the first point being a first center point of the blood vessel on a first side of the region of interest;
identify a second point disposed on the blood vessel, the second point being a second center point of the blood vessel on a second side of the region of interest; and
generate a curved planar reconstruction (CPR) image of a portion of the blood vessel, the portion including the region of interest;
determine the diameter of the blood vessel at the region of interest.

18. The system of claim 17, wherein the region of interest comprises a stenosis.

19. The system of claim 17, wherein the region of interest comprises an aneurysm.

20. The system of claim 17, further comprising receiving, prior to generating the CPR image, an adjustment of the first point from a user.

21. The system of claim 17, further comprising receiving, prior to generating the CPR image, an adjustment of the second point from a user.

22. The system of claim 17, further comprising displaying the diameter on a user interface.

23. The system of claim 17, further comprising determining a diagnosis based on the diameter and displaying the diagnosis on a user interface.

24. The system claim 17, further comprising providing a treatment method associated with the region of interest and based on the diameter of the blood vessel at the region of interest.
